(19) United States
(12) Patent Application Publication
(10) Pub. No.: US 2011/0125355 A1
(43) Pub. Date: May 26, 2011

(54) SYSTEM AND METHOD FOR CONTROLLING THE CHANGE IN MODE OF AN INFINITELY VARIABLE TRANSMISSION IN PURELY ELECTRIC MODE

(75) Inventors: Ahmed Ketfi-Cherif, Elancourt (FR); Gareth Pugsley, Bois D'Arcy (FR); Philippe Pognant-Gros, Tassin (FR)

(73) Assignee: RENAULT S.A.S., Boulogne-Billancourt (FR)

(21) Appl. No.: 12/936,487

(22) PCT Filed: May 4, 2009
(86) PCT No.: PCT/FR2009/050815

§ 371 Date: Feb. 2, 2011

(30) Foreign Application Priority Data
May 5, 2008 (FR) 0852975

(51) Int. Cl. B60W 20/00; B60W 10/06; B60W 10/10

(52) U.S. Cl. 701/22; 180/65.265; 903/902

(57) ABSTRACT

A system for controlling change in mode of an infinitely variable transmission including a first operation mode at high torque at high speed and a second operation mode at high torque at low speed, fitted to a motor vehicle that includes at least two electric machines, with at least one internal combustion engine. The infinitely variable transmission connected mechanically to the electric machines and to the internal combustion engine determines the internal combustion engine rotation speed setpoint; calculates the difference between the internal combustion engine rotation speed setpoint and the internal combustion engine rotation speed measurement; determines torque of the first electric machine to determine a torque setpoint for the first electric machine as a function of the difference between the rotation speed setpoint of the internal combustion engine and the measured rotation speed of the internal combustion engine; determines a torque setpoint for the second electric machine as a function of the torque setpoint of the first electric machine and the driver's demand for torque. The control system can control the second electric machine so that the change in mode can be performed while the vehicle is being propelled, before and after the change in mode, under sole action of at least one electric machine.

The field of the present invention is the control of transmissions and more particularly the control of infinitely variable transmissions.

Infinitely variable transmissions have taken off in particular with hybrid propulsion motor vehicles. Specifically, infinitely variable transmissions provide the possibility of modulating or increasing the torque delivered by a main drive source by varying the torques delivered by two secondary drive sources. In the case of a hybrid propulsion motor vehicle, the main drive source is an internal combustion engine or internal combustion engine, and the secondary drive sources are usually electric machines that can operate as an electric drive or as a recuperative breaking system.

Thus fitted, a hybrid vehicle is capable of simulating a gearbox by modulating the torque supplied by the internal combustion engine while maintaining it at an optimum operating speed, usually a low speed making it possible to limit the polluting emissions and the consumption of fuel.

However, the electric machines are known for having low torques compared with those of heat engines. To remedy these defects without increasing the contribution of the internal combustion engine, infinitely variable transmissions have been developed. These transmissions have two operating modes, one operating mode having high torques for a high speed of the vehicle, and one operating mode having high torques for a low speed of the vehicle. The two modes have a partial overlap of their speed ranges. Thus, depending on the speed range required by the driver, it is necessary to activate one or other of the infinitely variable transmission modes. An infinitely variable transmission with two modes is illustrated by the Renault patent applications FR2845514, FR2845515, FR2847321 and FR2844519.

Once a mode is activated, it is necessary to use the internal combustion engine, in order to provide an additional torque in the speed ranges in which the activated operating mode does not make it possible to supply a sufficient torque.

Such an operation puts a hybrid propulsion at some distance from a purely electric operation.

The subject of the present invention is a control system making it possible to change mode while running.

A further subject of the invention is a control system making it possible to limit the use of the internal combustion engine.

Another subject of the present invention is a control method making it possible to change mode while running.

According to one aspect of the invention, a system for controlling the change in mode of an infinitely variable transmission is defined comprising a first operating mode at high torque at high speed and a second operating mode at high torque at low speed, fitted to a motor vehicle also furnished with at least two electric machines with at least one internal combustion engine, the infinitely variable transmission being mechanically connected to the electric machines and to the internal combustion engine, characterized in that it comprises
a means for determining the setpoint of the rotation speed of the internal combustion engine,
an adder capable of making the difference between the setpoint of the rotation speed of the internal combustion engine and the measurement of the rotation speed of the internal combustion engine,
a means for determining the torque of the first electric machine capable of determining a torque setpoint of the first electric machine as a function of the difference between the setpoint of the rotation speed of the internal combustion engine and the measured rotation speed of the internal combustion engine, and
a compensation means capable of determining a torque setpoint of the second electric machine as a function of the torque setpoint of the first electric machine and of the request for torque from the driver.
The control system is capable of controlling the second electric machine so that the change in mode can be carried out while the vehicle is propelled, before and after the change in mode, under the sole action of at least one electric machine.

The control system may comprise a means for determining the setpoint of the rotation speed of the internal combustion engine capable of determining a setpoint of rotation speed of the internal combustion engine as a function of the speed of the vehicle.

The control system may comprise a means for determining the torque of the first electric machine, of Proportional Integral Derivative type, capable of determining a torque setpoint of the first electric machine as a function of the difference between the setpoint of the rotation speed of the internal combustion engine and the measured rotation speed of the internal combustion engine.

The control system may comprise a compensation means capable of determining a torque setpoint of the second electric machine as a function of the torque setpoint of the first electric machine and of the request for torque from the driver.

According to another aspect of the invention, a control is defined for controlling the change in mode at high torque at high speed and a second operating mode at high torque at low speed, fitted to a motor vehicle also furnished with at least two electric machines, with at least one internal combustion engine, the infinitely variable transmission being mechanically connected to the electric machines and to the internal combustion engine. The control method comprises steps during which:
the speed of the vehicle moving under the sole action of at least one electric machine is determined,
a change in operating mode of the infinitely variable transmission is initiated when the speed of the vehicle exceeds a speed for a change in operating mode,
the speed of the vehicle is maintained by driving said vehicle with the internal combustion engine,
the couplers are acted upon in order to change mode,
the internal combustion engine is slowed until it stops operating.

It is possible to determine a setpoint of rotation speed of the internal combustion engine as a function of the speed of the vehicle.

It is possible to determine a torque setpoint of the first electric machine by a calculation of the Proportional Integral Derivative type as a function of the difference between the setpoint of rotation speed of the internal combustion engine and the measured rotation speed of the internal combustion engine.

It is possible to determine a torque setpoint of the second electric machine as a function of the torque setpoint of the first electric machine and of the request for torque from the driver.

Other objects, features and advantages of the invention will appear on reading the following description, given only as a nonlimiting example and made with reference to the appended drawings in which:

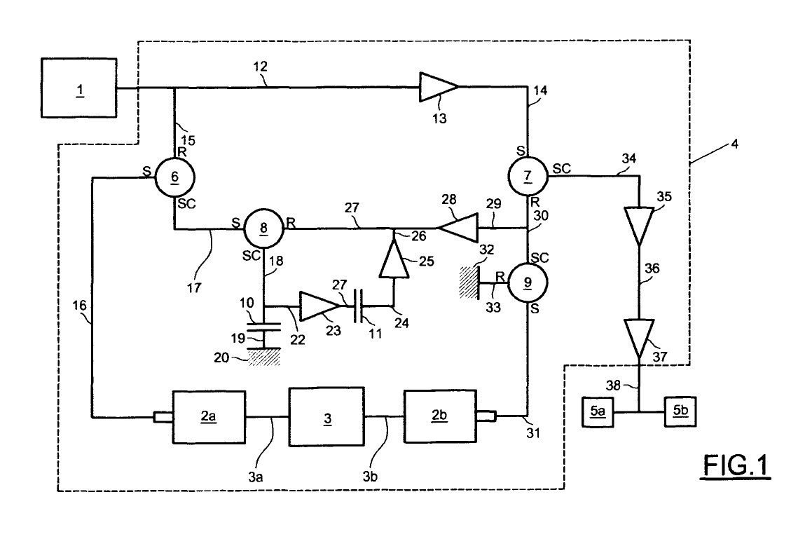

FIG. 1 illustrates the main elements included in a bi-mode infinitely variable transmission;

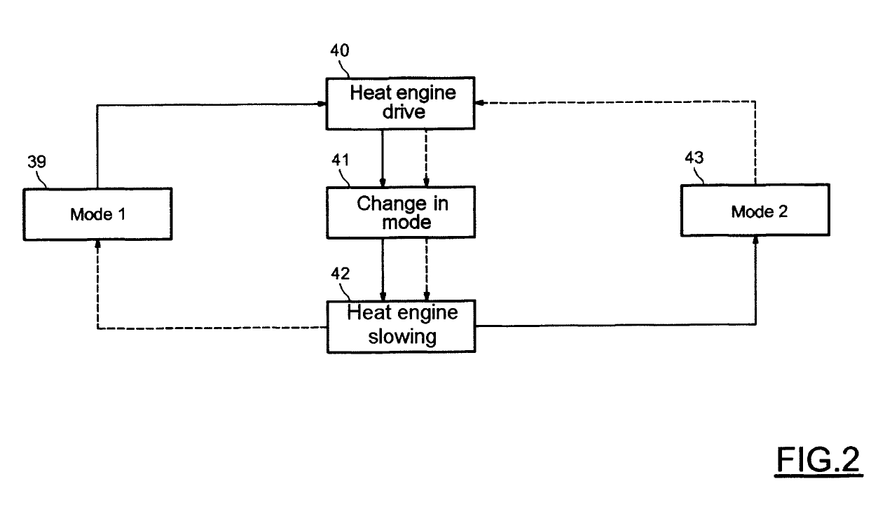

FIG. 2 illustrates the main steps included in a method for changing mode;

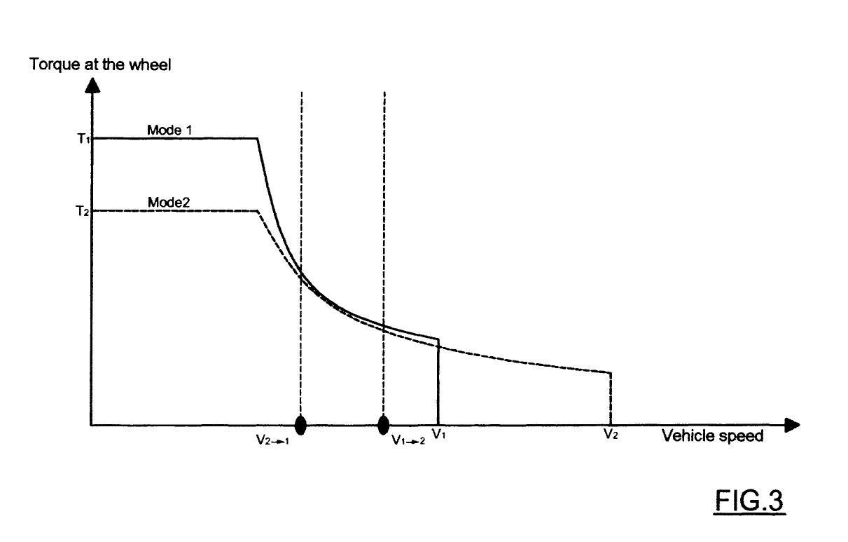

FIG. 3 illustrates the evolution of the torque at the wheel as a function of the speed of the vehicle for each of the modes of a bi-mode infinitely variable transmission; and

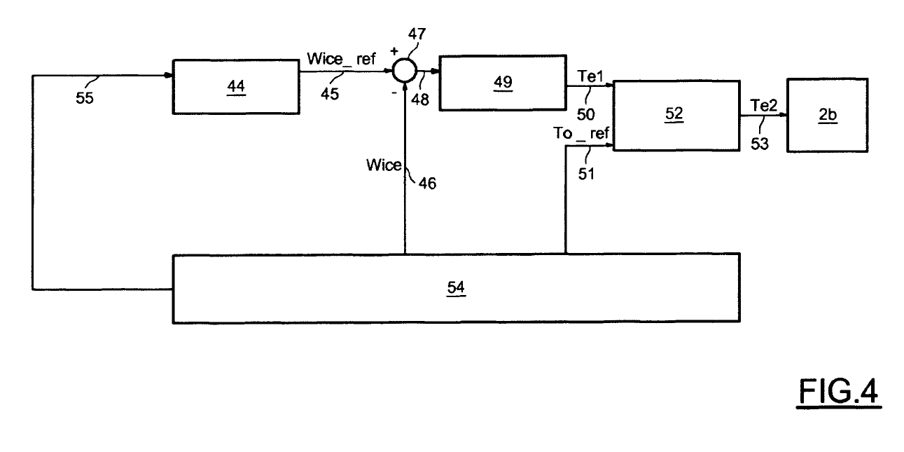

FIG. 4 illustrates the main elements included in a system for changing mode.

As illustrated as an example in FIG. 1, a hybrid drive train for a motor vehicle comprises an internal combustion engine 1, a first electric machine 2a, a second electric machine 2b, an electricity storage element 3 and an infinitely variable transmission 4 comprising four planetary gearsets 6, 7, 8 and 9, a first coupler 10, a second coupler 11, and two brakes 20 and 32.

The first planetary gearset 6 is connected by its ring gear R to the internal combustion engine 1 via the connection 15, by its planetary gear S to the first electric machine 2a via the connection 16, by its planet carrier SC to the planetary gear S of the second planetary gearset 8 via the connection 17. The planet carrier SC of the second planetary gearset 8 is connected to the first coupler 10 via the connection 18 and to the ring gear of the third planetary gearset 7 by means of the connection 27, the reduction gear 28 and the connection 29. The first coupler 10 is connected by its other end to the brake 20 via the connection 19. A connection 22 connected between the first coupler 10 and the second planetary gearset 8, is connected to the second coupler 11 by means of a reduction gear 23 and a connection 27. The other end of the second coupler 11 is connected to the ring gear R of the second planetary gearset 8 by means of a connection 24, a reduction gear 25 and a connection 26. The connection 26 is tapped between the second planetary gearset 8 and the reduction gear 28. The planetary gear S of the third planetary gearset 7 is connected to the internal combustion engine 1 by means of the connection 14, the reduction gear 13 and the connection 12. The ring gear R of the third planetary gearset 7 is also connected to the planet carrier SC of the fourth planetary gearset 9 via the connection 30. The ring gear R of the fourth planetary gearset 9 is connected to the brake 32 via the connection 33 and its planetary gear S is connected to the second electric machine 2b via the connection 31. The planet carrier SC of the third planetary gearset 7 is connected to a connection 34, followed by a reduction gear 35 itself connected to a reduction gear 37 via a connection 36, the reduction gear 37 being connected to a connection system 38 connected to the drive wheels 53. The first electric machine 2a and the second electric machine 2b are connected to the electricity storage element 3 via the connections 3a and 3b.

The infinitely variable transmission 4 illustrated by FIG. 1 comprises two operating modes. The change in mode is therefore provided by the first coupler 10 and the second coupler 11. A coupler is a mechanical element comprising two ends. In a general manner, when a coupler is closed, the rotation speeds at its ends must be equal.

If this restriction is applied to the situation of the bi-mode infinitely variable transmission, account has to be taken of the fact that the first coupler 10 is connected via one of its ends to the brake 20. When it is desired to close the first coupler 10, its end connected to the second planetary gearset 8 and to the second coupler 11 must have a rotation speed equal to that of the end connected to the brake 20. Thus, it is deduced from this that the rotation speeds at the ends of the first coupler 10 must be zero when it is closed.

Similarly, the second coupler 11 is connected by one of its ends to the second electric machine 2b and by the other end to the first coupler 10. When it is desired to close the second coupler 11, the speeds at its ends having to be equal, the rotation speeds of the second electric machine 2b and of one end of the first coupler 10 must be equal.

The first operating mode is achieved when the first coupler 10 is closed and the second coupler 11 open.

The second operating mode is achieved when the first coupler 10 is open and the second coupler 11 is closed. In order to have a stepless switch between the two modes, it is preferable to achieve it with speeds at the ends of the two couplers close to zero, which amounts to cancelling out the speed of the electric machine 2b.

Moreover, the couplers can be of different types. The main types are the multi-disk couplers or the ratchet couplers. The multi-disk couplers require a hydraulic system maintaining a pressure. The ratchet couplers use a complementarity of shape and do not require an active system to maintain them in place. They thus make it possible to achieve a saving in power consumption. In a hybrid vehicle that is economical on power, the solution of ratchet couplers is therefore preferably adopted. The operation of ratchet couplers requires a zero torque at their ends during an engagement or disengagement. Incorporating this condition results, in the case of a switch between the two operating modes, in the torque of the machine 2a having to be zero.

If consideration is given to the rotation speed of the internal combustion engine W_{ice}, the rotation speed of the first electric machine Wₑ₁, the rotation speed of the second electric machine Wₑ₂, the rotation speed of the output shaft W_{wh}, the following equations link these parameters in the context of an infinitely variable transmission.

For the first mode, this gives:

$$\{ \begin{matrix}{W}_{ice} = {A}_{1} \cdot {W}_{e 1} + {B}_{1} \cdot {W}_{e 2} \\ {W}_{wh} = {C}_{1} \cdot {W}_{e 1} + {D}_{1} \cdot {W}_{e 2}\end{matrix} \qquad ( eq . 1 )$$

where A₁, B₁, C₁ and D₁ are constant parameters.

For the second mode, this gives:

$$\{ \begin{matrix}{W}_{ice} = {A}_{2} \cdot {W}_{e 1} + {B}_{2} \cdot {W}_{e 2} \\ {W}_{wh} = {C}_{2} \cdot {W}_{e 1} + {D}_{2} \cdot {W}_{e 2}\end{matrix} \qquad ( eq . 2 )$$

where A₂, B₂, C₂ and D₂ are constant parameters.

Moreover this gives A₁=A₂ and C₁=C₂.

As specified above, the change in mode must be made at a zero rotation speed of the second electric machine.

It is deduced from the equation 1 or 2 that

$$\{ \begin{matrix}{W}_{ice} = {A}_{1} \cdot {W}_{e 1} \\ {W}_{wh} = {C}_{1} \cdot {W}_{e 1}\end{matrix} \qquad ( eq . 3 )$$

By replacing the expression of Wₑ₁ originating from one of the equations of the system of equations eq. 3, it gives:

$${W}_{wh} = \frac{{C}_{1}}{{A}_{1}} {W}_{ice} \qquad ( eq . 4 )$$

Thus, during a change in operating mode of the infinitely variable transmission, the rotation speed of the wheels is proportional to the rotation speed of the internal combustion engine.

To be able to change operating mode while the vehicle is moving and to comply with the requirement for a zero rotation speed of the second electric machine, the internal combustion engine is used to maintain the rotation speed of the wheels. A control method is defined on the basis of this finding. FIG. 2 illustrates the case in which the control method is applied to a change from the first operating mode to the second operating mode.

For a change in operating mode, from mode 1 to mode 2, the control method comprises the following steps.

During a step 39, the speed of the vehicle is compared with a limit speed of transition from mode 1 to mode 2, V_{1→2}. Once this speed is reached or exceeded, the method continues to step 40 during which the driving of the vehicle by the internal combustion engine is initiated by following a setpoint Wice_ref dependent on the speed V of the vehicle. The following formula is applied:

$$Wice\_ref = \frac{A 1}{C 1} \cdot \frac{V}{R}$$

During this phase, the electric machines simultaneously drive the heat engine and the vehicle.

The vehicle is driven by following a torque setpoint at the wheel To_ref.

During step 41, the couplers 10 and 11 are actuated in order to activate the second operating mode of the infinitely variable transmission.

The method continues to step 42 during which the internal combustion engine 1 is progressively slowed while providing the driving of the vehicle.

After the control method, the infinitely variable transmission 4, initially in the first operating mode, is configured in the second operating mode as symbolized by step 43 of the method.

The control method can be applied to a change in mode from the second operating mode to the first operating mode, considering, in particular, the limit speed of transition from mode 2 to mode 1, V_{2→1}.

FIG. 3 shows the evolution of the torque at the wheel as a function of the speed of the vehicle for each of the two operating modes of the infinitely variable transmission. The first mode makes it possible to obtain a torque T1 that decreases and that is cancelled out at the speed V1. The second mode makes it possible to obtain a torque T2, less than T1, that decreases and that exhibits a break at the speed V2, higher than V1. Thus, for the first mode, it can be seen that, at low speed, a torque is obtained that is higher than the torque in the second mode. Moreover, at a higher speed, the second mode makes it possible to obtain a torque where the first mode is no longer capable of supplying a torque to the wheel. The values V_{2→1} and V_{1→2} show the limit speeds from which a change in mode can be advantageous.

Similarly, the control method can be generalized in order to control the change between several operating modes of an infinitely variable transmission.

Moreover, the change in operating mode of an infinitely variable transmission can be controlled by a control system. Such a system, illustrated by FIG. 4, comprises the following main elements. A means 44 for determining the setpoint of rotation speed of the internal combustion engine is connected as an input via a connection 55 to sensors 54 and as an output to the positive input of an adder 47 via a connection 45. The adder 47 is connected via a connection 46 to the sensors 54 via a negative input and as an output, via a connection 48, to a means 49 for determining the torque of the first electric machine. A compensation means 52 is connected as an input to the sensors 54 via a connection 51 and to the means 49 for determining the torque of the first electric machine via a connection 50. The compensation means 52 is connected as an output to the second electric machine 26 via a connection 53.

The means 44 for determining the setpoint of rotation speed of the internal combustion engine 1 receives a value of the speed of the vehicle from the sensors 54. The determination means 44 generates as an output a setpoint value Wice_ref of rotation speed of the internal combustion engine 1. The means 49 for determining the torque of the first electric machine 2a determines, by a method of the proportional integral derivative type, a torque setpoint value Te1 of the first electric machine 2a as a function of the difference between the setpoint value Wice_ref and the measurement Wice of the rotation speed of the internal combustion engine originating from the sensors 54.

The compensation means 52 determines a torque setpoint value Te2 of the second electric machine as a function of the torque setpoint value Te1 of the first electric machine and of the torque request value To_ref received from the sensors 54. This setpoint Te2 is then transmitted to the second electric machine 2b.

Alternatively, it is possible to use a starter in order to drive the motor instead of the electric machines.

The control system and the control method make it possible to achieve a change in mode of an infinitely variable transmission comprising at least two operating modes and being fitted to a hybrid vehicle. This change in mode is made while the vehicle is moving under the action of its drive train, in particular, only under the action of the electric machines. The control system and the control method make it possible to carry out said change in mode without slowing the vehicle and while maintaining a degree of control of the speed of the vehicle.

1-7. (canceled)

8. A system for controlling a change in mode of an infinitely variable transmission including a first operating mode at high torque at high speed and a second operating mode at high torque at low speed, fitted to a motor vehicle including at least two electric machines with at least one internal combustion engine, the infinitely variable transmission being mechanically connected to the electric machines and to the internal combustion engine, the system comprising:
means for determining a setpoint of rotation speed of the internal combustion engine;
an adder configured to make a difference between the setpoint of the rotation speed of the internal combustion engine and a measurement of the rotation speed of the internal combustion engine;
means for determining torque of the first electric machine capable of determining a torque setpoint of the first electric machine as a function of the difference between the setpoint of the rotation speed of the internal combustion engine and the measured rotation speed of the internal combustion engine;
compensation means for determining a torque setpoint of the second electric machine as a function of the torque setpoint of the first electric machine and of a request for torque from the driver;
the control system configured to control the second electric machine so that the change in mode can be carried out while the vehicle is propelled, before and after the change in mode, under sole action of at least one electric machine.

9. The control system as claimed in claim 8, wherein the means for determining the setpoint of the rotation speed of the internal combustion engine is capable of determining a setpoint of rotation speed of the internal combustion engine as a function of the speed of the vehicle.

10. The control system as claimed in claim 9, wherein the means for determining the torque of the first electric machine is of Proportional Integral Derivative type.

11. A method for controlling a change in mode of an infinitely variable transmission including a first operating mode at high torque at high speed and a second operating mode at high torque at low speed, fitted to a motor vehicle including at least two electric machines, with at least one internal combustion engine, the infinitely variable transmission being mechanically connected to the electric machines and to the internal combustion engine, the method comprising:
determining speed of the vehicle moving under sole action of at least one electric machine;
initiating a change in operating mode of the infinitely variable transmission when the speed of the vehicle exceeds a speed for a change in operating mode;
maintaining the speed of the vehicle by driving the vehicle with the internal combustion engine;
acting upon couplers to change mode; and
slowing the internal combustion engine until it stops operating.

12. The control method as claimed in claim 11, wherein a setpoint of rotation speed of the internal combustion engine is determined as a function of the speed of the vehicle.

13. The control method as claimed in claim 11, wherein a torque setpoint of the first electric machine is determined by a calculation of Proportional Integral Derivative type as a function of the difference between the setpoint of rotation speed of the internal combustion engine and the measured rotation speed of the internal combustion engine.

14. The control method as claimed in claim 12, wherein a torque setpoint of the first electric machine is determined by a calculation of Proportional Integral Derivative type as a function of the difference between the setpoint of rotation speed of the internal combustion engine and the measured rotation speed of the internal combustion engine.

15. The control method as claimed in claim 11, wherein a torque setpoint of the second electric machine is determined as a function of the torque setpoint of the first electric machine and of a request for torque from the driver.

16. The control method as claimed in claim 12, wherein a torque setpoint of the second electric machine is determined as a function of the torque setpoint of the first electric machine and of a request for torque from the driver.

17. The control method as claimed in claim 13, wherein a torque setpoint of the second electric machine is determined as a function of the torque setpoint of the first electric machine and of a request for torque from the driver.

18. The control method as claimed in claim 14, wherein a torque setpoint of the second electric machine is determined as a function of the torque setpoint of the first electric machine and of a request for torque from the driver.
